(19) United States
(12) Patent Application Publication
(10) Pub. No.: US 2012/0226923 A1
(43) Pub. Date: Sep. 6, 2012

(54) POWER CONSUMPTION CONTROLLER, A POWER CONSUMPTION CONTROL SYSTEM, A POWER CONSUMPTION CONTROL METHOD AND A PROGRAM THEREOF

(75) Inventor: Osamu IKABATA, Tokyo (JP)

(73) Assignee: NEC Corporation, Tokyo (JP)

(21) Appl. No.: 13/407,654

(22) Filed: Feb. 28, 2012

(30) Foreign Application Priority Data
Mar. 1, 2011 (JP) 43872/2011

(51) Int. Cl. G06F 1/32; G06F 11/30

(52) U.S. Cl. 713/320

(57) ABSTRACT

A power consumption controller includes an input power monitoring unit, a load information monitoring unit, a redundancy configuration unit and a power control unit. The input power monitoring unit monitors an input power to a unit including a plurality of components. The load information monitoring unit measures a load of each of the components. The redundancy configuration unit stores information regarding an operation state of each of the components and extracts information regarding a configuration in which redundancy is maintained even if one of the components in operation is stopped. The power control unit detects whether or not the input power is over a predetermined value, selects a component having the smallest load among the components of the extracted configuration when the input power is over the predetermined value and switches the selected component into a power saving mode.

This application is based upon and claims the benefit of priority from Japanese patent application No. 2011-043872, filed on Mar. 1, 2011, the disclosure of which is incorporated herein in its entirety by reference.

### BACKGROUND

The exemplary embodiments of the present invention relate to a power consumption controller, a power consumption control system, a power consumption control method and a program thereof. Especially these embodiments relate to a power consumption controller, a power consumption control system, a power consumption control method and a program thereof capable of reducing power consumption of a unit including components of a redundant configuration.

### DESCRIPTION OF THE RELATED ART

Japanese Patent Application Laid-Open No. 1996-182194 (patent document 1) discloses a maximum demand power control apparatus that predicts a power consumption amount of a whole facility. The maximum demand power control apparatus transmits a power reduction signal which instructs to reduce power consumption to a power electric load according to a degree that the predicted power consumption amount exceeds a predetermined power consumption. A sensor node of the maximum demand power control apparatus in patent document 1 predicts power consumption by pulses from an integrating wattmeter which measures power consumption of a facility as a whole and outputs pulse signals of the number of pulse signals proportional to the measured power value. The sensor node transmits electric power alert information showing a degree that the predicted power consumption exceeds the predetermined power consumption to the control node of each power electric load. According to the received electric power alert information, each control node outputs a power reduction signal for reducing electric power to be consumed to a power electric load corresponding to each.

Japanese Patent Application Laid-Open No. 2009-159712 (patent document 2) discloses a disk array apparatus which sets an operation state of a controller module or a disk based on a future operation state determined based on an operation history of the controller module or the disk so that power consumption may become small while securing redundancy. For example, a disk array apparatus of patent document 2 has a redundant configuration of a plurality of disks, and selects a disk having the largest load among disks which can keep a redundant configuration even if each of them stops. The disk array apparatus of patent document 2 determines whether or not other disks can bear the load of the selected disk, and when it is determined that they can bear it, the operation of the selected disk is stopped.

In the patent document 1, it is not possible to reduce power consumption in a unit including a plurality of components by stopping any of components while maintaining the redundant configuration.

The disk array apparatus of patent document 2 sets an operation state of a controller module or a disk so that power consumption may become small in a predicted future operation situation. In the technology of patent document 2, there is a problem that, when power consumption of a whole disk array apparatus is measured and the measured power consumption exceeds a predetermined value, power consumption of the whole disk array apparatus cannot be reduced. Also, in a disk array apparatus of patent document 2, because a disk with the highest load is stopped and the load of the stopped disk is burdened to other disks, a load of disks besides the stopped disk increases. Because power consumption is increased for the disks for which a load is increased, there is also a problem that power consumption of the whole disk array apparatus may not decrease.

An object of the exemplary embodiments of the present invention is to provide a power consumption controller, a power consumption control system, a power consumption control method and a program thereof capable of decreasing influence on each component in a unit including a plurality of components and reducing the input power to the unit while maintaining a redundant configuration of the components in the unit, when the input power to the unit exceeds a predetermined value,

### SUMMARY OF THE INVENTION

According to a non-limiting illustrative embodiment, a power consumption controller comprising: an input power monitoring unit configured to monitor an input power to a unit including a plurality of components; a load information monitoring unit configured to measure a load of each of the components; a redundancy configuration unit configured to store information regarding an operation state of each of the components and extract information regarding a configuration in which redundancy is maintained even if one of the components in operation is stopped; and a power control unit configured to detect whether or not the input power is over a predetermined value, to select a component having the smallest load among the components of the extracted configuration when the input power is over the predetermined value and to switch the selected component into a power saving mode.

According to another non-limiting illustrative embodiment, a power consumption control system comprising: a unit including a plurality of components; a power supply apparatus configured to supply power to the unit; and a power consumption controller configured to control an input power supplied form the power supply apparatus to the unit, wherein the power consumption controller comprises: an input power monitoring unit configured to monitor the input power to the unit; a load information monitoring unit configured to measure a load of each of the components; a redundancy configuration unit configured to store information regarding an operation state of each of the components and extract information regarding a configuration in which redundancy is maintained even if one of the components in operation is stopped; and a power control unit configured to detect whether or not the input power is over a predetermined value, to select a component having the smallest load among the components of the extracted configuration when the input power is over the predetermined value and to switch the selected component into a power saving mode.

According to another non-limiting illustrative embodiment, a power consumption control method comprising: monitoring an input power to a unit including a plurality of components; measuring a load of each of the components; storing information regarding an operation state of each of the components in a redundancy configuration unit; extracting information regarding a configuration in which redundancy is maintained even if one of the components in operation is stopped; detecting whether or not the input power is over a predetermined value; selecting a component having the smallest load among the components of the extracted configuration when the input power is over the predetermined value; and switching the selected component into a power saving mode in a switching step.

According to another non-limiting illustrative embodiment, a computer readable medium recording thereon a program for enabling a computer to carry out the following: monitoring an input power to a unit including a plurality of components; measuring a load of each of the components; storing information regarding an operation state of each of the components in a redundancy configuration unit; extracting information regarding a configuration in which redundancy is maintained even if one of the components in operation is stopped; detecting whether or not the input power is over a predetermined value; selecting a component having the smallest load among the components of the extracted configuration when the input power is over the predetermined value; and switching the selected component into a power saving mode in a switching step.

### BRIEF DESCRIPTION OF THE DRAWING

The above and other aspects of the present invention will become more apparent by describing in detail exemplary embodiments thereof with reference to the attached drawings in which:

FIG. 1 is a diagram illustrating a structure of a first exemplary embodiment in the present invention;

FIG. 2 is a diagram illustrating a structure of an example of a unit;

FIG. 3 is a flow chart illustrating an operation of the first exemplary embodiment;

FIG. 4 is a diagram illustrating a structure of a second exemplary embodiment in the present invention;

FIG. 5 is a flow chart illustrating an operation of the second exemplary embodiment; and

FIG. 6 is a diagram illustrating a structure of a third exemplary embodiment in the present invention.

### DETAILED DESCRIPTION

The first exemplary embodiment of the present invention will be explained in detail with reference to drawings.

The embodiments of the present invention will be described in detail referring to the drawings. Each exemplary embodiment of the present invention indicated below can be realized by hardware, a computer and a computer program which controls a computer, or a combination of hardware, a computer and a computer program which controls a computer.

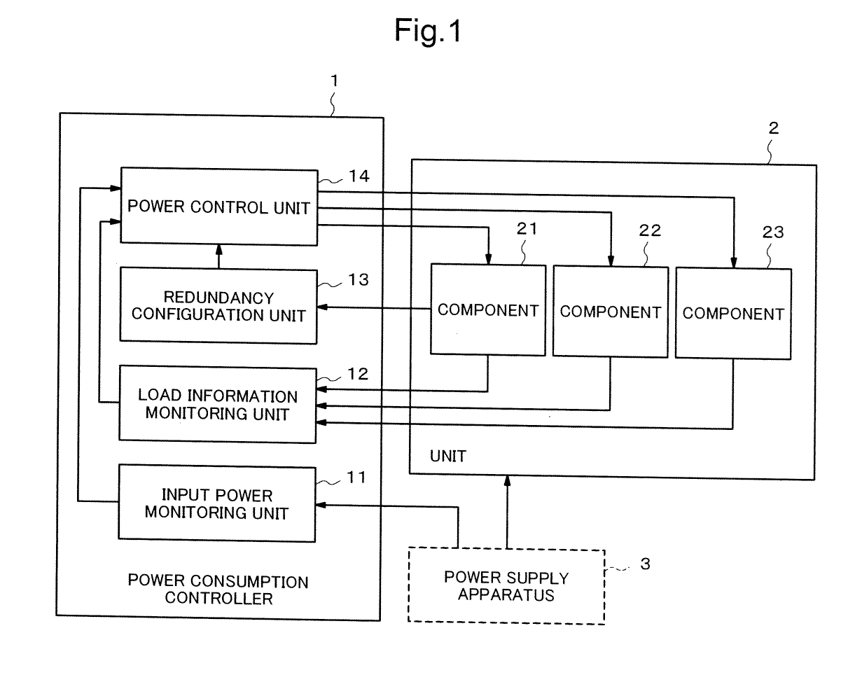

FIG. 1 is a diagram illustrating a structure of the first exemplary embodiment of the present invention.

Referring to FIG. 1, a power consumption controller 1 of this exemplary embodiment includes an input power monitoring unit 11, a load information monitoring unit 12, a redundancy configuration unit 13 and a power control unit 14.

The power consumption controller 1 is connected to a unit 2 and a power supply apparatus 3.

The unit 2 includes a plurality of components (a component 21, a component 22 and a component 23). Although the number of the component is three in the example of FIG. 1, it should be of any number that is no smaller than three. However, even if any one among these components is stopped, the remaining components maintain a redundant configuration. That is, even if any two among these components are stopped, by a remaining component operating, the unit 2 can continue operating.

The unit 2 is a disk array apparatus, for example. When the unit 2 is a disk array apparatus, the unit 2 includes a plurality of hard disks as a component. When the unit 2 is a disk array apparatus, the mounting configuration of the disk array apparatus is RAID (Redundant Arrays of Independent Disks) having redundancy, for example. As an example of RAID having redundancy, there is RAID-TM (Triple Mirror). A structure of a disk array apparatus of the unit 2 may be of other structures such as RAID 6.

The unit 2 may be a processor array, for example. The component in this case is a processor. The unit 2 may be a computer cluster. The component in this case is a computer. The unit 2 may include a plurality of kinds of components such as a hard disk and a processor.

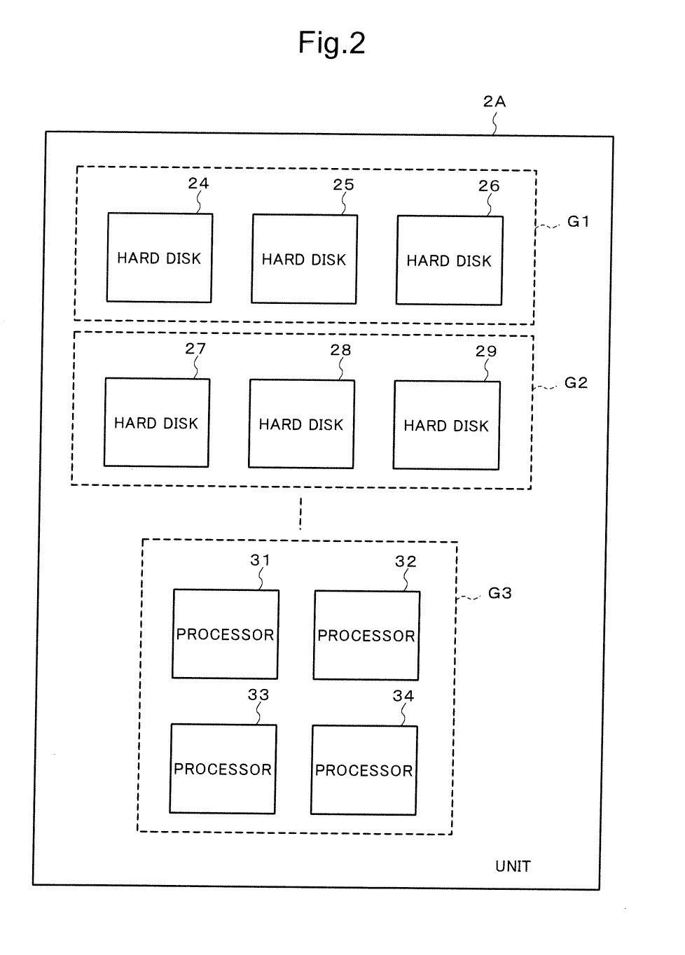

FIG. 2 is a diagram illustrating an example of a structure of a unit 2A including a plurality of kinds of components.

Referring to FIG. 2, the unit 2A includes a plurality of hard disks (hard disks 24-29) and a plurality of processors (processors 31-34).

In FIG. 2, a disk array G1 of the RAID-TM structure is composed of hard disks 24-26. A disk array G2 of the RAID-TM structure is composed of hard disks 27-29. A processor array G3 is composed of processors 31-34.

In the following, description when the structure of the unit 2 is a structure shown in FIG. 1 will be made mainly.

The power supply apparatus 3 supplies electric power to the unit 2.

The input power monitoring unit 11 of the power consumption controller 1 measures the input power that the power supply apparatus 3 inputs to the unit 2. The input voltage to the unit 2 measured by the input power monitoring unit 11 corresponds to power consumption of the unit 2.

The load information monitoring unit 12 measures a load of each component.

From the components included in the unit 2, the redundancy configuration unit 13 extracts a component that, even when it is stopped separately, the still operating components included in the unit 2 maintain a redundant configuration.

When input power to the unit 2 (power consumption of the unit 2) measured by the input power monitoring unit 11 exceeds a predetermined value, the power control unit 14 selects a component with the smallest load measured by the load information monitoring unit 12 from the components extracted by the redundancy configuration unit 13. The power control unit 14 switches the operation of the selected component into a power saving mode to reduce power consumption which the switched component has been consuming. For example, the power control unit stops the operation of the selected component. The power saving mode includes a standby mode and a shut down mode. Generally, it is called degraded operation to operate while separating a certain component from a plurality of components of a redundant configuration. In the description of each exemplary embodiment of the present invention, transcription which says “(the operation of) a component is stopped” means that the component is degenerated, supply of electric power to the component is suspended and the operation of the component is stopped.

Next, an operation of this exemplary embodiment will be described in detail with reference to a drawing.

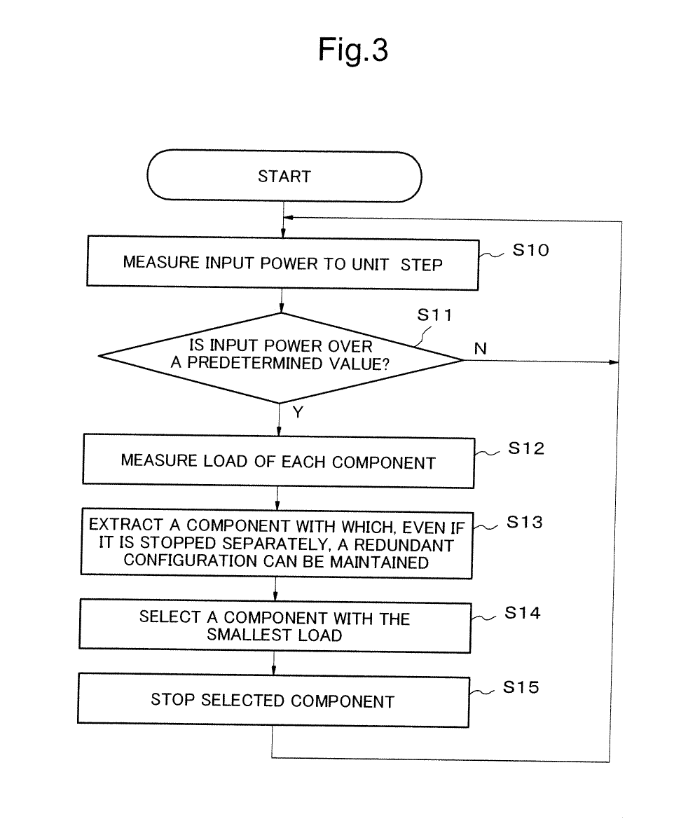

FIG. 3 is a flow chart illustrating an operation of this exemplary embodiment.

Referring to FIG. 3, an input power monitoring unit 11 measures the input voltage from the power supply apparatus 3 to the unit 2, first (Step S11).

Instead of measuring the input power directly, the input power monitoring unit 11 may receive a numerical value of the input power that the power supply apparatus 3 inputs to the unit 2 from a wattmeter, which is not illustrated, provided in the power supply apparatus 3, for example.

The power control unit 14 determines whether the input voltage measured by the input power monitoring unit 11 is over a predetermined value or not (Step S11). The predetermined value that becomes the standard when the power control unit 14 performs determination should set in advance by an administrator of the power consumption controller 1, for example, via a terminal which is not illustrated, for example.

When the power control unit 14 determines that the input voltage is below the predetermined value (N in Step S11), the process returns to Step S10.

When the power control unit 14 determines that the input voltage is over the predetermined value (Y in Step S11), the load information monitoring unit 12 measures a load of each component (Step S12). The load information monitoring unit 12 should measure the load of each component upon receipt of an instruction from the power control unit 14. In stead of following an instruction from the power control unit 14, the load information monitoring unit 12 may perform measurement of a load of each component at a predetermined time interval, for example.

When a component is a hard disk, a load is the number of accesses per a unit time or a transfer volume of data per a unit time (the amount of data written or the amount of read data), for example. When a component is a processor, a load is a usage rate of the processor, for example. When the unit 2 includes a plurality of components, a numerical value which is made by assigning numerical values of measured loads of the different kinds to an identical index appropriately should be made be a load. When a component is a hard disk and a measured load is the number of accesses per a unit time, for example, a numerical value of a load should be obtained by setting the number of accesses per a unit time that the hard disk can process as 100 in advance and obtaining the number of accesses per the unit time that has been measured on a pro-rate basis. When a component is a processor, for example, the percentage of the usage rate of the processor should be used as a numerical value of a load. The load information monitoring unit 12 should receive a numerical value showing the size of a load from a controller of the unit 2 which is not illustrated, for example.

Next, the redundancy configuration unit 13 extracts, among a plurality of components, a component with which, even if it is stopped separately, a redundant configuration can be maintained (Step S13).

The redundancy configuration unit 13 should store information on a combination of components of which a redundant configuration is composed in advance. In the example of FIG. 1, the redundancy configuration unit 13 should store information that the component 21, the component 22 and the component 23 are of a combination forming a redundant configuration. In the example of the unit 2A of FIG. 2, the redundancy configuration unit 13 should store information that each of the disk array G1, the disk array G2 and the processor array G3 is a combination forming a redundant configuration.

The redundancy configuration unit 13 should receive an operation state that is information showing whether each component included in the unit 2 is operating or stopping from the unit 2 or the power control unit 14, for example. The redundancy configuration unit 13 should extract, among the above-mentioned combinations of the components forming a redundant configuration, a combination in which no smaller than three operating components are included based on the operation state of each component. The redundancy configuration unit 13 should extract a component included in the combination as a component with which a redundant configuration is maintained even when it is stopped separately.

In the example of FIG. 1, when all of the components 21-23 are operating, for example, the redundancy configuration unit 13 receives an operation state showing that all components are operating from the power control unit 14, for example, first. When all of the components 21-23 forming a redundant configuration are operating, because two other components operate even if any one of the components 21-23 is stopped, a redundant configuration of the unit 2 is maintained. In this case, as a combination in which no smaller than three operating components are included, the redundancy configuration unit 13 extracts a combination including the components 21-23 among the combinations of components forming a redundant configuration. The redundancy configuration unit 13 extracts all of the components 21-23 as components with which the unit 2 maintains a redundant configuration when stopping any one of the components separately.

On the other hand, when the component 21, for example, is being stopped, the redundancy configuration unit 13 receives an operation state showing that only the component 21 is being stopped from the power control unit 14, for example, first. In this case, because the component 22 and the component 23 operate even if the component 21 is stopped, the combination of the components 21-23 forms a redundant configuration. However, this combination includes only two operating components. When any one of the component 22 and the component 23 is stopped, a redundant configuration of the unit 2 is not maintained. In this case, because a combination which includes no smaller than three operating components does not exist in the combinations of components forming a redundant configuration, the redundancy configuration unit 13 does not extract a combination of the components. Because an extracted combination does not exist, the redundancy configuration unit 13 does not extract a component.

Also, when the redundancy configuration unit 13 extracts a component with which a redundant configuration can be maintained even if it is stopped separately from the unit 2A of FIG. 2, it should be extracted as follows, for example. In the unit 2A of FIG. 2, when only the hard disk 24 is being stopped, for example, the redundancy configuration unit 13 receives an operation state showing that only the hard disk 24 is being stopped from the unit 2 or the power control unit 14, for example. In the case of this example, the redundancy configuration unit 13 stores information that each of the disk array G1, the disk array G2 and the processor array G3 is a combination forming a redundant configuration as mentioned above.

Operating components of the disk array G1 are two of the hard disk 25 and the hard disk 26. When one of the hard disk 25 and the hard disk 26 is stopped, a redundant configuration of the disk array G1 portion of the unit 2 is not maintained. On the other hand, operating components included in the disk array G2 are three of the hard disks 27-29. Operating components included in the processor array G3 are four of the processors 31-34. Even if one of the hard disks 27-29 and processors 31-34 are stopped, redundancy of the disk array G2 portion and the processor array G3 portion of the unit 2 is maintained.

In this case, among the disk array G1, the disk array G2 and the processor array G3 forming a redundant configuration, the redundancy configuration unit 13 should extract the disk array G2 and the processor array G3 in which no smaller than three operating components are included. The redundancy configuration unit 13 should extract them as components with which the unit 2 maintains a redundant configuration even when the hard disks 27-29 and the processors 31-34 included in the disk array G2 and the processor array G3 that have been extracted are stopped separately.

The power control unit 14 selects a component with the smallest load measured by the load information monitoring unit 12 among the components extracted by the redundancy configuration unit 13 (Step S14).

For example, when the redundancy configuration unit 13 extracts all of the components 21-23 from the unit 2 of FIG. 1, the power control unit 14 should select a component with the smallest load from the components 21-23.

The power control unit 14 stops the selected component (Step S15) and reduces power consumption by the stopped component.

Following are effects of the exemplary embodiment described above.

In this exemplary embodiment, when input power to the unit 2 including a plurality of components exceeds a predetermined value, it is possible to suppress influence on each component in the unit 2 to a minimum and to reduce the input power to the unit 2 while maintaining a redundant configuration of the components in the unit 2.

This exemplary embodiment also has an effect that it is possible to select and stop a component with the highest electric power reduction effect while maintaining a redundant configuration of the components in the unit 2.

The reason is that the power control unit 14 selects and stops a component with the smallest load measured by the load information monitoring unit 12 among components extracted by the redundancy configuration unit 13 with which a redundant configuration can be maintained even if they are stopped separately. By the power control unit 14 stopping a component with the smallest measured load, increase of loads of the other components that is influence on the other components by suspension of the component becomes smallest. Accordingly, the power consumption controller 1 can keep influence by a reduction in input power on each component in the unit 2 to a minimum and reduce the input power to the unit 2 while maintaining a redundant configuration of the components in the unit 2. Also, because increase of the loads of the other components by suspension of a component becomes smallest, increase of power consumption of the other components along with increase of a load also becomes smallest. Accordingly, an electric power reduction effect by the power control unit 14 stopping a selected component is high.

Next, the second exemplary embodiment of the present invention will be described in detail with reference to a drawing.

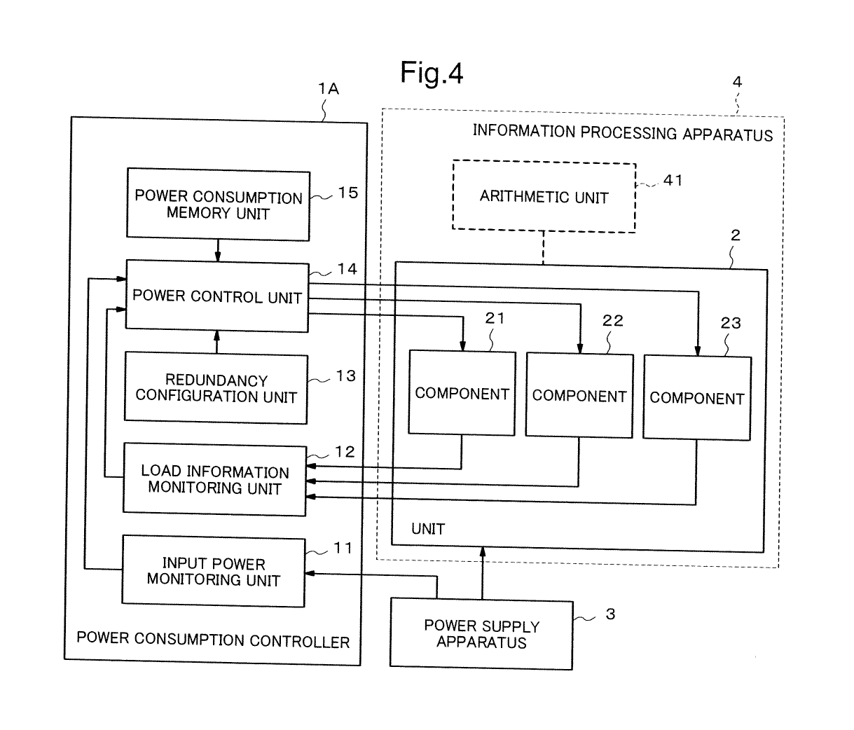

FIG. 4 is a block diagram illustrating a structure of this exemplary embodiment.

When FIG. 4 and FIG. 1 are compared, a power consumption controller 1A of this exemplary embodiment is different in a point that it includes a memory unit such as a power consumption memory unit 15 compared with the power consumption controller 1 of the first exemplary embodiment, the structure of which is shown in FIG. 1. The unit 2 may be included in an information processing apparatus 4. The information processing apparatus 4 may include an arithmetic unit 41 which is a computer connected to the unit 2, for example.

The power consumption memory unit 15 of the power consumption controller 1A stores information regarding a power consumption which each component consumes.

When there are a plurality of components having the smallest load measured by a load information monitoring unit 12 among components extracted by a redundancy configuration unit 13, a power control unit 14 of this exemplary embodiment selects a component with the largest numerical value of power consumption stored in the power consumption memory unit 15. On this occasion, if there are a plurality of components having the largest numerical value of power consumption, the power control unit 14 should select one component from these components by an optional means. The power control unit 14 of this exemplary embodiment is the same as the power control unit 14 of the first exemplary embodiment in the other points.

Because the other elements constituting this exemplary embodiment are the same as the elements constituting the first exemplary embodiment to which the identical numbers with FIG. 1 are attached, description will be omitted.

Next, an operation of this exemplary embodiment will be described in detail with reference to a drawing.

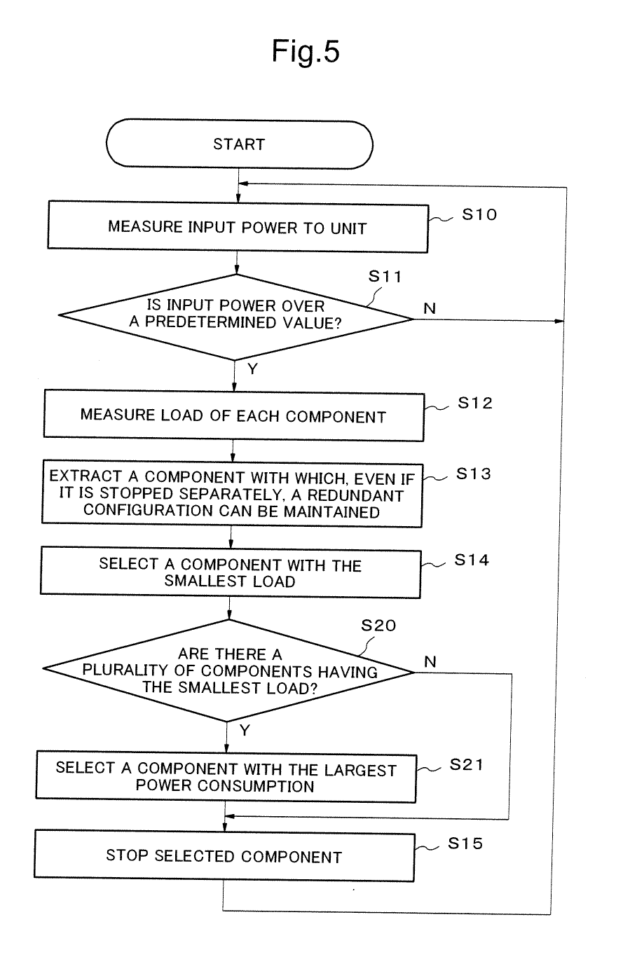

FIG. 5 is a flow chart illustrating the operation of this exemplary embodiment.

Referring to FIG. 5, because the operation of Steps S10-S14 of this exemplary embodiment is the same as the operation of Steps S10-S14 of the first exemplary embodiment, description will be omitted.

When, among the components extracted by the redundancy configuration unit 13, there is only one component having the smallest load measured by the load information monitoring unit 12 (N in Step S20), the process advances towards Step S15.

When, among the components extracted by the redundancy configuration unit 13, there are a plurality of components having the smallest load measured by the load information monitoring unit 12 (Y in Step S20), the power control unit 14 reads the power consumption of these components from the power consumption memory unit 15. The power control unit 14 compares the read pieces of power consumption, and selects a component with the largest power consumption among the plurality of components selected in Step S14 (Step S21), and the process advances towards Step S15.

The power control unit 14 stops the selected component (Step S15) and reduces power consumption by the stopped component.

This exemplary embodiment described above has the same effect as the first exemplary embodiment.

The reason is that the power control unit 14 selects and stops a component with the smallest load measured by the load information monitoring unit 12 among components extracted by the redundancy configuration unit 13 with which a redundant configuration can maintained even if they are stopped separately.

This exemplary embodiment also has an effect that, when input power to the unit 2 including a plurality of components exceeds a predetermined value, it is possible to select and stop a component with a higher electric power reduction effect while maintaining a redundant configuration of the components in the unit 2.

The reason is that, when there are a plurality of components with the smallest load among components selected by the redundancy configuration unit 13, the power control unit 14 selects and stops a component with the largest power consumption.

Next, the third exemplary embodiment of the present invention will be described in detail with reference to a drawing.

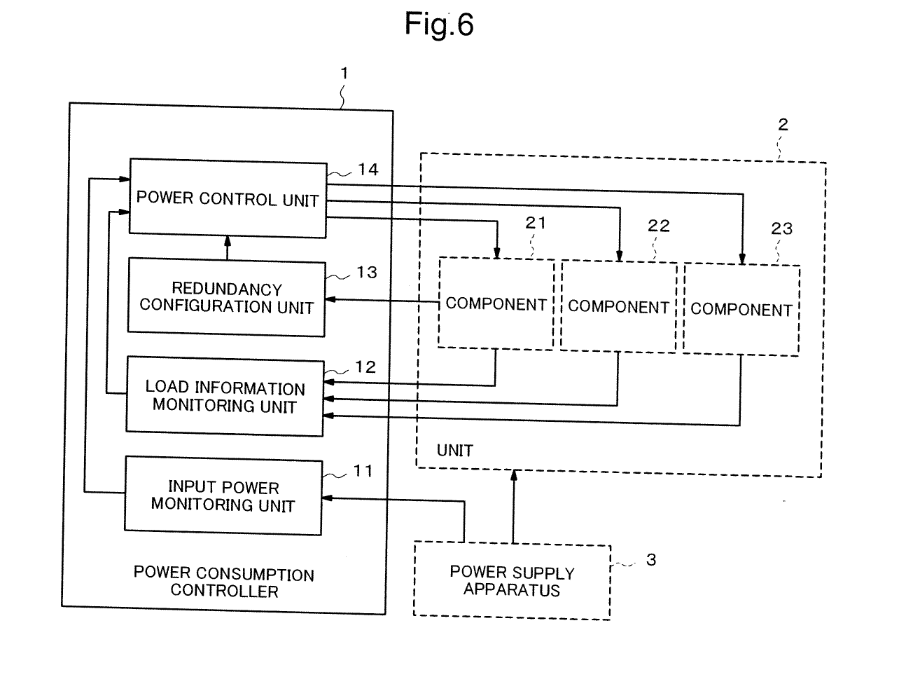

FIG. 6 is a diagram illustrating a structure of this exemplary embodiment.

The power consumption controller 1 of this exemplary embodiment includes: an input power monitoring unit 11, a load information monitoring unit 12, a redundancy configuration unit 13 and a power control unit 14. The input power monitoring unit 11 measures input power to a unit 2 including a plurality of components. The load information monitoring unit 12 measures a load of each of the components. The redundancy configuration unit 13 stores an operation state of each of the components in the unit 2, and extracts, a component enabling the unit 2 to maintain a redundant configuration when stopped separately, among each of the operating components. The power control unit 14 selects a component having the smallest load from components enabling the unit 2 to maintain a redundant configuration when they are stopped separately, when the input power being over a predetermined value. Then the power control unit 14 stops an operation of the selected component.

Following are effects of this exemplary embodiment described above.

This exemplary embodiment has an effect that, when input power to the unit 2 including a plurality of components exceeds a predetermined value, it is possible to suppress influence on each component in the unit 2 to a minimum and to reduce the input power to the unit 2 while maintaining a redundant configuration of the components in the unit 2.

The reason is that the power control unit 14 selects and stops a component with the smallest load measured by the load information monitoring unit 12 among components that are extracted by the redundancy configuration unit 13 with which a redundant configuration can be maintained even if they are stopped separately.

Although the present invention has been described with reference to the exemplary embodiments above, the present invention is not limited to the above-mentioned exemplary embodiments. Various modifications which a person skilled in the art can understand within the scope of the present invention can be made in the composition and details of the present invention.

What is claimed is:

1. A power consumption controller comprising:
an input power monitoring unit configured to monitor an input power to a unit including a plurality of components;
a load information monitoring unit configured to measure a load of each of the components;
a redundancy configuration unit configured to store information regarding an operation state of each of the components and extract information regarding a configuration in which redundancy is maintained even if one of the components in operation is stopped; and
a power control unit configured to detect whether or not the input power is over a predetermined value, to select a component having the smallest load among the components of the extracted configuration when the input power is over the predetermined value and to switch the selected component into a power saving mode.

2. The power consumption controller according to claim 1, further comprising a memory unit configured to store a power consumption value of each of the components,
wherein when there are a plurality of the components having the smallest load, the power control unit switches a component having the largest power consumption value among the components having the smallest load, into the power saving mode.

3. The power consumption controller according to claim 1,
wherein the unit is a disk array apparatus and the component is a hard disk.

4. A power consumption control system comprising:
a unit configured to include a plurality of components;
a power supply apparatus configured to supply power to the unit; and
a power consumption controller configured to control an input power supplied form the power supply apparatus to the unit,
wherein the power consumption controller comprises:
an input power monitoring unit configured to monitor the input power to the unit;
a load information monitoring unit configured to measure a load of each of the components;
a redundancy configuration unit configured to store information regarding an operation state of each of the components and extract information regarding a configuration in which redundancy is maintained even if one of the components in operation is stopped; and
a power control unit configured to detect whether or not the input power is over a predetermined value, to select a component having the smallest load among the components of the extracted configuration when the input power is over the predetermined value and to switch the selected component into a power saving mode.

5. The power consumption control system according to claim 4,
wherein the power consumption controller comprises a memory unit configured to store a power consumption value of each of the components, and
wherein when there are a plurality of the components having the smallest load, the power control unit switches a component having the largest power consumption value among the components having the smallest load, into the power saving mode.

6. The power consumption control system according to claim 4,
wherein the unit is a disk array apparatus and the component is a hard disk.

7. A power consumption control method comprising:
monitoring an input power to a unit including a plurality of components;
measuring a load of each of the components;
storing information regarding an operation state of each of the components in a redundancy configuration unit;
extracting information regarding a configuration in which redundancy is maintained even if one of the components in operation is stopped;
detecting whether or not the input power is over a predetermined value;
selecting a component having the smallest load among the components of the extracted configuration when the input power is over the predetermined value; and
switching the selected component into a power saving mode in a switching step.

8. The power consumption control method according to claim 7, further comprises: storing a power consumption value of each of the components in a memory unit,
wherein a component having the largest power consumption value among the components having the smallest load is switched into the power saving mode when there are a plurality of the components having the smallest load, in the switching step.

9. The power consumption control method according to claim 8,
wherein the unit is a disk array apparatus and the component is a hard disk.

10. A computer readable medium recording thereon a program for enabling a computer to carry out the following:
monitoring an input power to a unit including a plurality of components;
measuring a load of each of the components;
storing information regarding an operation state of each of the components in a redundancy configuration unit;
extracting information regarding a configuration in which redundancy is maintained even if one of the components in operation is stopped;
detecting whether or not the input power is over a predetermined value;
selecting a component having the smallest load among the components of the extracted configuration when the input power is over the predetermined value; and
switching the selected component into a power saving mode in a switching step.

11. The computer readable medium according to claim 10,
wherein a power consumption value of each of the components is stored in a memory unit, and
wherein a component having the largest power consumption value among the components having the smallest load is switched into the power saving mode when there are a plurality of the components having the smallest load, in the switching step.

12. The computer readable medium according to claim 10,
wherein the unit is a disk array apparatus and the component is a hard disk.
